(19) United States
(12) Patent Application Publication
(10) Pub. No.: US 2006/0038429 A1
(43) Pub. Date: Feb. 23, 2006

(54) Fastening device for connecting structural parts to a first and second molded wall unit

(75) Inventor: Thomas Bauer, Eppingen-Muhlbach (DE)

Correspondence Address: DARBY & DARBY P.C., P. O. BOX 5257, NEW YORK, NY, 10150-5257, US

(73) Assignee: Utescheny AG, Zaisenhausen (DE)

(21) Appl. No.: 11/027,029

(22) Filed: Dec. 30, 2004

Related U.S. Application Data
(63) Continuation of application No. PCT/DE03/01903, filed on Jun. 10, 2003.

(30) Foreign Application Priority Data
Jul. 8, 2002 (DE) 202 10 614.4

(51) Int. Cl. B60N 3/02

(52) U.S. Cl. 296/214; 74/543

(57) ABSTRACT

A fastening device (10) for connecting components, in particular roof grab handles or the like, to a first molded wall unit, in particular molded roof lining (20) of a vehicle, and to a second molded wall unit, in particular bodyshell (22) of a vehicle, having a bearing device (14) with a continuous recess (16), at least one fastening means (18) which can be inserted into the recess (16) for fastening purposes, the bearing device (14) having a stop unit (24) which, in the fitted state, i.e. after the bearing device (14) has passed through in some regions into a first recess (44) present on the molded wall unit, bears against the inner surface of the first molded wall unit (20), is distinguished in that the bearing device (14) has at least one fastening lever (28) which can be rotated about an axis of rotation (26) and is operatively connected directly or indirectly to the fastening means (18) in such a manner that, when the fastening means (18) is inserted over a defined first insertion distance, the fastening lever (28) is pivoted outward and fixed, so that a clamping connection of the first molded wall unit (20) can be produced between the fastening lever (28) and the stop unit (24) (pre-assembly state), it being possible for the connection to the second molded wall unit (22) to be produced by defined further insertion of the fastening means (18) over a second insertion distance (E2) (final assembly state).

### TECHNICAL FIELD

The present invention relates to a fastening device for connecting components, in particular roof grab handles or the like, to a first molded wall unit, in particular molded roof lining of a vehicle, and to a second molded wall unit, in particular body shell of a vehicle, having a bearing device with a continuous recess, at least one fastening means which can be inserted into the recess for fastening purposes, the bearing device having a stop unit which, in the pre-assembled and final assembled state, i.e. after the bearing device has been passed through in some regions into a first recess present on the first molded wall unit, bears against the inner surface of the first molded wall unit.

### PRIOR ART

Hoop-like roof grab handles for vehicles are known, the limb ends of which are mounted rotatably in each case on a pillow block. The pillow blocks are fastened to the body shell of the vehicle via fastening means, with a molded roof lining to be fitted between the body shell and roof grab handle. Roof grab handles of this type are described, for example, in European patent specification 685 359, 569 022 or German utility model 295 06 397.

### SUMMARY OF THE INVENTION

Starting from the prior art mentioned, the present invention is based on the technical problem or the object of specifying a fastening device and a component with a fastening device of this type, which is oriented on the principle of few components, can be produced cost-effectively, permits simple pre-assembly on the first molded wall unit, offers advantages with regard to the final assembly on the second molded wall unit and ensures simple removal.

The fastening device according to the invention is provided by the features of independent claim 1. Advantageous refinements and developments are the subject matter of the claims directly or indirectly dependent on claim 1.

Accordingly, the fastening device according to the invention is distinguished in that the bearing device has at least one fastening lever which can be rotated about an axis of rotation and is operatively connected directly or indirectly to the fastening means in such a manner that, when the fastening means is inserted over a defined first insertion distance, the fastening lever is pivoted outward and fixed, so that a clamping connection of the first molded wall unit can be produced between the fastening lever and the stop unit (pre-assembly state), it being possible for the connection to the second molded wall unit to be produced by defined further insertion of the fastening means over a second insertion distance (final assembly state).

A particularly preferred first variant embodiment according to the invention is distinguished in that the fastening means is designed as a screw having a bushing surrounding its screw shank in some regions, in the non-assembled state one end side of the bushing bearing against the screw head and the other end side of the bushing bearing in some regions against the fastening lever, and, in the pre-assembly state, the fasting lever bearing in some regions against the outer wall of the bushing.

An advantageous second variant embodiment according to the invention is distinguished in that the fastening means is designed as a plug-in rivet, in the non-assembled state that end side of the plug-in rivet which lies opposite the head side of the plug-in rivet being in contact with the fastening lever and, in the pre-assembly state, the fastening lever bearing in some regions against the outer wall of the plug-in rivet, two expanding limbs being integrally formed on the bearing device and, by further insertion of the plug-in rivet over the second insertion distance, being fastenable in a recess of the second molded wall unit.

A particularly advantageous development is distinguished in that the fastening means is present on the fastening device in a captively releasable manner.

The use of the principle of few parts is possible according to the invention by the fact that the fastening device is already connected to the component. The pre-assembler is therefore provided with an entire component which he can merely connect to the first molded wall unit (molded roof lining) in a simple manner. After the pre-assembly of the components via the fastening device on the molded roof lining, the latter is supplied to the car manufacturer who can fit the molded roof lining with components to the body shell of the vehicle in a simple manner.

In a structurally particularly simple variant embodiment, the fastening means, in the non-assembled state, is retained on the fastening device in a captively releasable manner as a thin, penetrable, plate-like securing unit.

According to a particularly preferred variant embodiment, it is particularly advantageous in respect of functionality and economic producibility to arrange the securing unit in such a manner that it forms a stop which can be overcome for the end of the first insertion distance.

According to a further variant embodiment, the captively releasable fastening of the fastening means to the fastening device is characterized in that the fastening means has a latching unit which, in the non-assembled state, can be latched releasably in a first mating latching unit present in the continuous recess of the bearing device and/or which, in the pre-assembly state, can be latched releasably in a second mating latching unit present in the continuous recess of the bearing device.

The defined position of the fastening means within the bearing device in the pre-assembled state is ensured in a reliable manner by the second mating latching unit.

A structurally particularly simple variant embodiment permitting a simple assembly process is distinguished in that the latching unit is designed as a projection unit, in particular having a cross section with a partially circular profile, and the first and second mating latching units are designed as a groove unit, in particular with a partially circular contour, or vice versa.

There are preferably at least two diametrically opposite fastening levers. However, there may also be a plurality of fastening levers.

In a particularly advantageous, economically producible refinement, the axis of rotation of the fastening lever is formed by a molded-on film hinge.

The fastening lever may also be designed as a separate component, in particular clipped-in component.

A structurally particularly advantageous development, which ensures permanently reliable functioning and a simple pre-assembly and final assembly process, is distinguished in that the fastening lever has a first bearing surface and a second bearing surface arranged essentially perpendicularly to the first bearing surface, in the non-assembled state the end side of the fastening means bearing in some regions against the first bearing surface and, by insertion of the fastening means over the first insertion distance (pre-assembly state), the fastening lever can be rotated through approx. 90° (degrees) in such a manner that, in this pre-assembly state, the first bearing surface bears against the side wall of the fastening means and the second bearing surface bears against the first molded wall unit.

A particularly great advantage of the fastening device according to the invention resides in the fact that it can be removed in a simple manner. In the case of the second variant embodiment according to the invention with the plug-in rivet, the plug-in rivet is simply drawn off and then the fastening device can be removed.

In the case of the first variant embodiment with the fastening means designed as a screw with a bushing, the simple removal is ensured by the fact that the bushing has a slot recess which is assigned to the fastening lever and is arranged in such a manner that, in the final assembly state, it is situated at the same height as the fastening lever, the inner contour of the slot recess being designed in such a manner that the fastening lever can be pivoted at least in some regions through the slot recess.

According to a variant embodiment, which can be produced particularly economically, the fastening device or at least the bearing device is designed as a plastic part, in particular extruded plastic part.

A molded roof lining according to the invention for the interior of a vehicle is distinguished in that it has at least one component with at least one fastening device in the manner described above.

The fastening device according to the invention with the connected component makes optimum use of the principle of few components. Just one component is supplied to the pre-assembler who can fasten the latter cost-effectively to the roof lining within the course of a simple pre-assembly process. In the final assembly of the roof lining with the components connected via the fastening device, it is particularly advantageous to provide trough-shaped indentations on the bodyshell, at the points to which the fastening device is to be connected, which are suitable, in respect of their cross-sectional shape, for receiving that region of the bearing device which protrudes over the roof lining. This makes it possible already to relatively precisely pre-position the position in which the roof lining is to be assembled, since the recess provided in the body shell for the connection of the fastening means is already situated in the axial direction of the fastening means.

Further embodiments and advantages of the invention emerge through the features furthermore described in the claims and through the exemplary embodiments indicated below. The features of the claims may be combined with one another in any desired manner unless they clearly rule one another out.

### BRIEF DESCRIPTION OF THE DRAWING

The invention and advantageous embodiments and developments of the same are described and explained in greater detail below with reference to the examples illustrated in the drawing. The features which can be gathered from the description and the drawing can be used, according to the invention, individually on their own or a number of them can be used in any desired combination. In the drawing:

FIG. 1 shows a schematic section through a roof grab handle with a connected fastening device according to a first variant embodiment, the fastening means being designed as a screw with a screw bushing which acts on the fastening lever, in the non-assembled state,

FIG. 2 shows the schematic sectional illustration of the roof grab handle according to FIG. 1 in the state in which it is pre-assembled on the roof lining,

FIG. 3 shows a schematic sectional illustration of the roof grab handle according to FIG. 2 in the state in which it is assembled on the body shell,

FIG. 4 shows a schematic plan view of the fastening device according to FIG. 1 (without bodyshell, roof lining and roof grab handle),

FIG. 5 shows a schematic section through a roof grab handle with the connected fastening device according to a second variant embodiment, the fastening means being designed as a plug-in rivet which acts on fastening levers, in the non-assembled state,

FIG. 6 shows a schematic side view of the fastening device according to FIG. 5,

FIG. 7 shows a schematic sectional illustration of the fastening device according to FIG. 5 in the state in which it is pre-assembled on the roof lining, and

FIG. 8 shows a schematic sectional illustration of the fastening device according to FIG. 7 in the state in which it is assembled on the bodyshell.

### WAYS OF IMPLEMENTING THE INVENTION

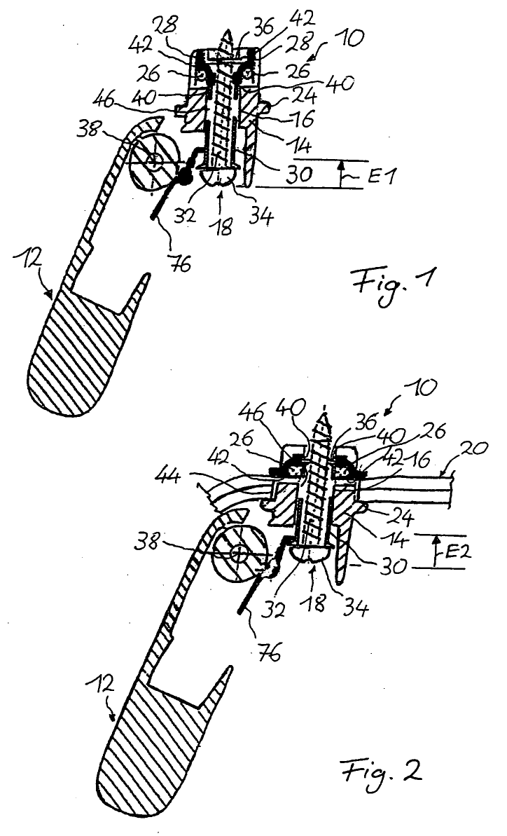

FIGS. 1 to 4 illustrate a first exemplary embodiment of a fastening device 10 which is connected to a roof grab handle 12. The pivotable connection of the roof grab handle 12 to the fastening device 10 is not illustrated specifically in the figures. Connecting constructions of this type can be gathered from the prior art.

The fastening device 10 has a bearing device 14 with a stop unit 24 which is integrally formed circumferentially on it and is designed as a projection unit. At the upper end of FIG. 1, two limbs 48 are integrally formed on the bearing device 14 and between them there is a slot recess 46 which is open to the sides and upward (see FIG. 4).

The bearing device 14 has a recess 16 which is continuous from the bottom to the top. Arranged within the continuous recess 16 and also within the slot recess 46 is a fastening means which is designed as a screw 18 with a screw shank 32 and a screw had 34.

A bushing 30 is arranged around the screw shank 32 of the screw 18, the outer wall of which bushing bears in some regions against the inner wall of the continuous recess 16.

There is a fastening lever 28, which can be rotated about an axis of rotation 26, in the slot recess 46, in each case offset outward with respect to the longitudinal axis of the screw 18. Each fastening lever has a horizontal first bearing surface 40, which faces downward in FIG. 1, and a second bearing surface 42, which is at right angles to the first bearing surface 40 and faces outward in FIG. 1. The length of the bushing 30 is selected in such a manner that it bears on the inside with its lower end side against the screw head 34 and with its upper end side against the first bearing surface 40 of each fastening lever 28. A securing unit 36, which is designed as a penetrable plate unit, is molded on in the upper end region of the limbs 48 as a screw securing means, as a result of which the screw 18 together with the bushing 30 is retained captively in the bearing device 44.

FIG. 1 illustrates the non-assembled state of the fastening device 10 with the roof grab handle 12. The component is supplied in this state to the pre-assembler.

The screw 18 together with the bushing 30 is arranged in the continuous recess 16 (retained by the securing unit 36) with a predetermined projecting length with respect to the lower end side of the bearing device 14.

In the pre-assembly process, first of all the two limbs 48 of the fastening device 10 are introduced into a first recess 44, which is present on a molded roof lining 20, until the stop unit 24 bears against the lower side of the molded roof lining 20 (see FIG. 2). The next assembly process involves rotating the screw 18 until it has covered the insertion distance E1 (FIG. 1). While the screw 18 is being inserted, the bushing 30 acts on the two fastening levers 28 in such a manner that they execute a rotation to the outside about their particular axis of rotation 26. After the first insertion position has been reached (arrow E1), the upper end side of the bushing 30 strikes against the film hinge 36 which forms a reliable, unambiguous pre-assembly stop. The fastening levers 28 are pivoted outwards through approx. 90° (degrees) in this state, so that the second bearing surface 42 comes into contact with the upper side of the molded roof lining 20. At the same time in this state, the first bearing surface 40 bears against the side wall of the bushing 30. The molded roof lining 20 is therefore retained in a clamping manner between the stop unit 24 and the second bearing surface 42. This pre-assembly state is illustrated in FIG. 2.

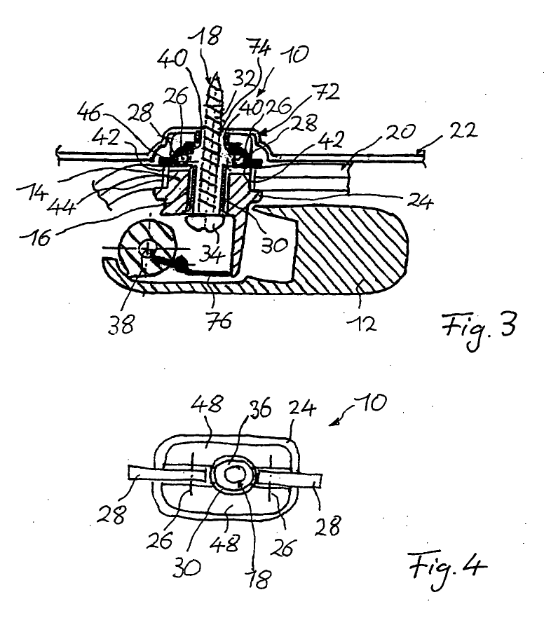

In this pre-assembly state, the molded roof lining 20 with the roof grab handle connected via the fastening device 10 is supplied to the car manufacturer who then connects the molded roof lining with the roof grab handle to a body shell 22 of a vehicle (FIG. 3).

In the final assembly operation according to FIG. 3, it is particularly advantageous that the bodyshell 22 has, in the region in which the fastening device 10 is connected, a depression trough 72 which corresponds essentially approximately to the contour of the limbs 48, which protrude on the top side over the molded roof lining 20, and fastening levers 28 of the fastening device 10. In the center of the trough 72 there is a second recess 74 into which the screw 18 is screwed with the insertion distance E2 (FIG. 2) being covered, as a result of which a permanently reliable connection between the body shell 22 and molded roof lining 20 with fastening device 10 and roof grab handle 12 is ensured. The provision of the trough 72 affords great advantages in terms of assembly, since, when the molded roof lining 20 is fitted, it is already pre-positioned, which ensures a simple final assembly.

The roof grab handle 12 is designed as a folding handle which is mounted rotatably about an axis of rotation 38 counter to a spring unit (not illustrated in the figures). The spring unit acts on the folding handle 12 in such a manner that, in the normal state, it assumes the position illustrated in FIG. 3, i.e. essentially parallel to the molded roof lining 20. The roof grab handle 12 can then be swung upward manually counter to the action of this spring unit. In order to keep the screw head 34 of the screw 18 free during the pre-assembly process and final assembly process, there is additionally a cover element 76 which retains the roof grab handle 12 in an open position in a latching manner (as illustrated in FIGS. 1 and 2). After the assembly is finished, this cover element 76, which is molded on releasably, can have its latching function removed and, according to FIG. 3, can be clipped on as a covering, with the result that, when the device 10 is fitted, the screw 18 is not visible to the outside.

The fastening device 10 according to the invention has the further great advantage of being able easily to be removed again, which has a positive effect with regard to recycling problems. For removal purposes, the screw 18 is unscrewed from the fastening device 10 by rotation. As a result, the connection to the body shell 22 is released. The connection to the molded roof lining 20 is released by simply pulling the fastening device 10 out of the first recess 44. This is possible, since, in the final assembly state, there are slot recesses 46 in the outer wall of the bushing 30 that lie opposite the position of the fastening levers 28, which have an internal contour such that the fastening levers 28 can be pivoted through said slot recesses. The slot recesses 46 are arranged on the bushing 30 in such a manner that, in the final assembly state according to FIG. 3, they are arranged level with the fastening levers 28. If the bearing unit 14 with the bushing 30 is now removed from the molded roof lining 20, the fastening levers 28 can pivot inward through the particular slot recesses 46, so that the bearing device 14 can be removed.

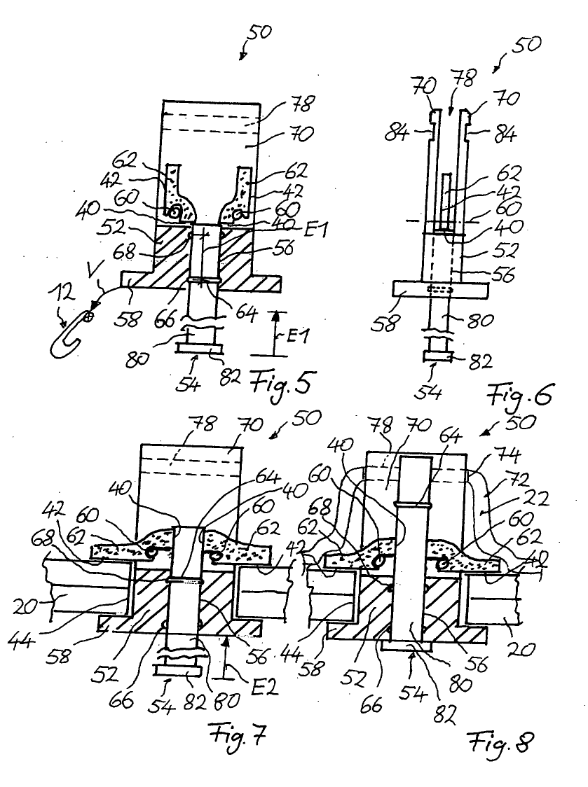

FIGS. 5 to 8 illustrate a second exemplary embodiment of a fastening device 50 which, with regard to the pre-assembly process, operates according to the same principle of expanding fastening levers 62. The fastening device 50 has a bearing device 52 with an encircling stop unit 58, which is designed as a projection. The stop unit 58 comes to rest against the lower side of the molded roof lining 20. The bearing device 52 likewise has a continuous, central recess 56 into which a fastening means 54, which is designed as a plug-in rivet 54, can be introduced. At the upper end of the figures, on the bearing unit 52 there are two expanding limbs 70 which face upward, are spaced apart and between which is formed a slot 78 in which the fastening levers 62, which are fastened rotatably on axis of rotation 60 offset outward with respect to the continuous recess 56, are arranged. In terms of their structural configuration, the fastening levers 62 correspond to the fastening levers 28 of the fastening device 10 and are not described again in detail.

In addition, the fastening device 50 is connected to a roof grab handle 12, which is illustrated schematically in FIG. 5, the connection in FIG. 5 being illustrated symbolically by the symbol arrow V.

FIG. 5 illustrates a fastening device 50 in the non-assembled state. The shank 80 of the plug-in rivet 54 has a latching unit 64 which, in the exemplary embodiment illustrated, is of encircling design in the form of a rounded projection unit slightly protruding outward.

The continuous recess 56 has a first mating latching unit 66 and a second mating latching unit 68 arranged at a distance—corresponding to the insertion distance E1. In the exemplary embodiment illustrated, both mating latching units 66, 68 are designed as an encircling, rounded groove, corresponding to the molded contour of the latching unit 64. In the non-assembled state, the latching unit 64 is latched releasably in the first mating latching unit 66, so that the plug-in rivet 54 is present captively on the bearing device 52. In this state, that end side of the shank 80 which lies opposite the head 82 of the plug-in rivet 54 strikes in each case against the first bearing surface 40 of the two fastening levers 62.

For pre-assembly of the fastening device 50 on the molded roof lining 20, the bearing device 52 with its expanding limbs 70 is introduced into the first recess 44 of the molded roof lining 20 until the stop unit 58 strikes against the lower side of the molded roof lining 20. The plug-in rivet 54 is then displaced into the continuous recess 56 by the insertion extent E1, so that, as already described in the above exemplary embodiment, the fastening levers 62 rotate outward through approx. 90° (degrees) and come with their second bearing surfaces 42 into contact with the upper side of the molded roof lining 20. Since, in this state, the first bearing surfaces 40 of the fastening levers 62 bear against the outer wall of the plug-in rivet 54, the fastening levers 62 are fixed in their position. In this pre-assembled state, the latching unit 64 of the plug-in rivet 54 latches into the second mating latching unit 68 of the continuous recess 56, as a result of which an unambiguous pre-assembly position of the plug-in rivet 54 is ensured. This state is illustrated in FIG. 7.

In the final assembly process, the expanding limbs 70 are introduced into the second recess 74 of the depression trough 72 of the body shell 22 and then the plug-in rivet 54 is pushed further into the continuous recess 56 by the insertion extent E2 (FIG. 7) until the head 82 strikes against the lower side of the bearing evice 52. The shank 80 of the plug-in rivet 54 is displaced into the slot 78 of the expanding limbs 70 which, expanding as a result in the second recess 74 of the bodyshell 22, are reliably fixed. On the outside, the expanding limbs 70 have connecting grooves 84 which correspond essentially to the wall thickness of the bodyshell 22 in the region of the depression trough 72. The wall of the bodyshell 22 engages in these grooves 84 in the assembled state.

In order to release the connection, first of all the plug-in rivet 54 is simply removed. Then the bearing device 52 together with its expanding limbs 70 can be removed, since, when the plug-in rivet 54 is removed, the fastening levers 62 can pivot freely inward and the expanding action of the plug-in rivet 56 is stopped.

The fastening device according to the invention may also be used for lighting devices, clothes hooks, compartments for spectacles, oddments trays or similar components to be fastened to the bodywork.

1. A fastening device (10; 50) for connecting components, in particular roof grab handles or the like, to a first molded wall unit, in particular molded roof lining (20) of a vehicle, and to a second molded wall unit, in particular body shell (22) of a vehicle, having
a bearing device (14; 52) with a continuous recess (16; 56),
at least one fastening means (18; 54) which can be inserted into the recess (16; 56) for fastening purposes,
the bearing device (14; 52) having a stop unit (24; 58) which, in the fitted state, i.e. after the bearing device (14; 52) has passed through in some regions into a first recess (44) present on the first molded wall unit, bears against the inner surface of the first molded wall unit (20), characterized in that
the bearing device (14; 52) has at least one fastening lever (28; 62) which can be rotated about an axis of rotation (26; 60),
and is operatively connected directly or indirectly to the fastening means (18; 54) in such a manner that, when the fastening means (18; 54) is inserted over a defined first insertion distance (E1), the fastening lever (28; 62) is pivoted outward and fixed, so that a clamping connection of the first molded wall unit (20) can be produced between the fastening lever (28; 62) and the stop unit (24; 58) (pre-assembly state), it being possible for the connection to the second molded wall unit (22) to be produced by defined further insertion of the fastening means (18; 54) over a second insertion distance (E2) (final assembly state).

2. The fastening device as claimed in claim 1, characterized in that
the fastening means is designed as a screw (18) having a bushing (30) surrounding its screw shank (32) in some regions, in the non-assembled state one end side of the bushing (30) bearing against the screw head (34) and the other end side of the bushing (30) bearing in some regions against the fastening lever (28), and, in the pre-assembly state, the fasting lever (28) bearing in some regions against the outer wall of the bushing (30).

3. The fastening device as claimed in claim 1, characterized in that
the fastening means is designed as a plug-in rivet (54), in the non-assembled state that end side of the plug-in rivet (54) which lies opposite the head side (82) of the plug-in rivet (54) being in contact with the fastening lever (62) and, in the pre-assembly state, the fastening lever (62) bearing in some regions against the outer wall of the plug-in rivet (54), two expanding limbs (70) being integrally formed on the bearing device (52) and, by further insertion of the plug-in rivet (54) over the second insertion distance (E2), being fastenable in a recess of the second molded wall unit (22).

4. The fastening device as claimed in any of the preceding claims, characterized in that
the fastening means (18; 54) is present on the fastening device (10; 50) in captively releasable manner.

5. The fastening device as claimed in claim 4, characterized in that
the fastening means (18), in the non-assembled state, is retained on the fastening device (10; 50) in a captively releasable manner as a thin, penetrable, plate-like securing unit (36).

6. The fastening device as claimed in any of claims 1-3, characterized in that
there is a securing unit (36) which is arranged in such a manner that it forms a stop which can be overcome for the end of the first insertion distance (E1).

7. The fastening device as claimed in claim 4, characterized in that
the fastening means (54) has a latching unit (64) which, in the non-assembled state, can be latched releasably in a first mating latching unit (66) present in the continuous recess (56) of the bearing device (52) and/or which, in the pre-assembly state; can be latched releasably in a second mating latching unit (68) present in the continuous recess (56) of the bearing device (52).

8. The fastening device as claimed in claim 7, characterized in that
the latching unit (64) is designed as a projection unit, in particular having a cross section with a partially circular profile, and the first and second mating latching units (66, 68) are designed as a groove unit, in particular with a partially circular contour, or vice versa.

9. The fastening device as claimed in any of claims 1-3, characterized in that
there are at least two diametrically opposite fastening levers (28; 62).

10. The fastening device as claimed in any of claims 1-3, characterized in that
the axis of rotation (26; 60) is formed by a molded-on film hinge.

11. The fastening device as claimed in any of claims 1-3, characterized in that
the fastening lever (28; 62) is designed as a separate component, in particular clipped-in component.

12. The fastening device as claimed in claims 1-3, characterized in that
the fastening lever (28; 62) has a first bearing surface (40) and a second bearing surface (42) arranged essentially perpendicularly to the first bearing surface (40), in the non-assembled state the end side of the fastening means (18; 54) bearing in some regions against the first bearing surface (40) and, by insertion of the fastening means (18; 54) over the first insertion distance E1, (pre-assembly state), the fastening lever (28; 62) can be rotated through approx. 90° (degrees) in such a manner that, in this pre-assembly state, the first bearing surface (40) bears against the side wall of the fastening means (18; 54) and the second bearing surface (42) bears against the first molded wall unit (20).

13. The fastening device as claimed in claim 2, characterized in that
the bushing (30) has a slot recess (46) which is assigned to the fastening lever (28) and is arranged in such a manner that, in the final assembly state, it is situated at the same height as the fastening lever (28), the inner contour of the slot recess (46) being designed in such a manner that the fastening lever (28) can be pivoted at least in some regions through the slot recess.

14. The fastening device as claimed in any of claims 1-3, characterized in that
the fastening device (10; 50) or the bearing device (14; 52) is designed as a plastic part, in particular extruded plastic part.

15. The fastening device as claimed in any of claims 1-3, characterized in that
at least one fastening device (10; 50) together with the component (12) forms a constructional unit.

16. A molded roof lining for the interior of a vehicle, characterized in that
it has at least one component with at least one fastening as claimed in any of claims 1-3.
